(19) United States
(12) Patent Application Publication
(10) Pub. No.: US 2003/0043794 A1
(43) Pub. Date: Mar. 6, 2003

(54) Data stream multiplexing in data network

(76) Inventors: Phil C. Cayton, Beaverton, OR (US); Ellen M. Deleganes, Beaverton, OR (US); Frank L. Berry, North Plains, OR (US)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/946,347

(22) Filed: Sep. 6, 2001

(51) Int. Cl. H04Q 11/00

(52) U.S. Cl. 370/386; 370/388

(57) ABSTRACT

A technique for multiplexing data streams in a data network. To avoid copying the data when it is sent, the technique utilizes different operations such as the RDMA Read and RDMA Write operation. By utilizing this approach rather than the standard send and receive operations, it is not necessary to copy the data so that the number of messages and interrupts is reduced, thus reducing latency and the use of CPU time.

### FIELD

The present invention relates to a technique of multiplexing data streams and more particularly relates to a technique for multiplexing data streams in a data network using remote direct memory access instructions.

### BACKGROUND

A data network generally consists of a network of multiple independent and clustered nodes connected by point-to-point links. Each node may be an intermediate node, such as a switch/switch element, a repeater, and a router, or an end-node within the network, such as a host system and an I/O unit (e.g., data servers, storage subsystems and network devices). Message data may be transmitted from source to destination, often through intermediate nodes.

Existing interconnect transport mechanisms, such as PCI (Peripheral Component Interconnect) buses as described in the “PCI Local Bus Specification, Revision 2.1” set forth by the PCI Special Interest Group (SIG) on Jun. 1, 1995, may be utilized to deliver message data to and from I/O devices, namely storage subsystems and network devices. However, PCI buses utilize a shared memory-mapped bus architecture that includes one or more shared I/O buses to deliver message data to and from storage subsystems and network devices. Shared I/O buses can pose serious performance limitations due to the bus arbitration required among storage and network peripherals as well as posing reliability, flexibility and scalability issues when additional storage and network peripherals are required. As a result, existing interconnect technologies have failed to keep pace with computer evolution and the increased demands generated and burden imposed on server clusters, application processing, and enterprise computing created by the rapid growth of the Internet.

Emerging solutions to the shortcomings of existing PCI bus architecture are InfiniBand™ and its predecessor, Next Generation I/O (NGIO) which have been developed by Intel Corporation to provide a standards-based I/O platform that uses a switched fabric and separate I/O channels instead of a shared memory-mapped bus architecture for reliable data transfers between end-nodes, as set forth in the “Next Generation Input/Output (NGIO) Specification,” NGIO Forum on Jul. 20, 1999 and the “InfiniBand™ Architecture Specification,” the InfiniBand™ Trade Association published in October 2000. Using NGIO/InfiniBand™, a host system may communicate with one or more remote systems using a Virtual Interface (VI) architecture in compliance with the “Virtual Interface (VI) Architecture Specification, Version 1.0,” as set forth by Compaq Corp., Intel Corp., and Microsoft Corp., on Dec. 16, 1997. NGIO/InfiniBand™ and VI hardware and software may often be used to support data transfers between two memory regions, typically on different systems over one or more designated channels. Each host system using a VI Architecture may contain work queues (WQ) formed in pairs including inbound and outbound queues in which requests, in the form of descriptors, are posted to describe data movement operation and location of data to be moved for processing and/or transportation via a data network. Each host system may serve as a source (initiator) system which initiates a message data transfer (message send operation) or a target system of a message passing operation (message receive operation). Requests for work (data movement operations such as message send/receive operations and remote direct memory access “RDMA” read/write operations) may be posted to work queues associated with a given network interface card. One or more channels between communication devices at a host system or between multiple host systems connected together directly or via a data network may be created and managed so that requested operations can be performed.

The idea of multiplexing has been used in many situations previously, and especially in systems such as telephone systems. This allows multiple signals to be carried by a single wire such as by intermixing time segments of each of the signals. In systems such as a data network hardware channels can carry additional streams of data by sharing the channel among different data streams. Traditionally, a send instruction is used for this purpose. However, this type of operation requires that the data be copied in the process of moving the data to the destination.

### BRIEF DESCRIPTION OF THE DRAWINGS

The foregoing and a better understanding of the present invention will become apparent from the following detailed description of example embodiments and the claims when read in connection with the accompanying drawings, all forming a part of the disclosure of this invention. While the foregoing and following written and illustrated disclosure focuses on disclosing example embodiments of the invention, it should be clearly understood that the same is by way of illustration and example only and that the invention is not limited thereto. The spirit and scope of the present invention are limited only by the terms of the appended claims.

The following represents brief descriptions of the drawings, wherein:

FIG. 1 illustrates an example data network having several nodes interconnected by corresponding links of a basic switch according to an embodiment of the present invention;

FIG. 2 illustrates another example data network having several nodes interconnected by corresponding links of a multi-stage switched fabric according to an embodiment of the present invention;

FIG. 3 illustrates a block diagram of an example host system of an example data network according to an embodiment of the present invention;

FIG. 4 illustrates a block diagram of an example host system of an example data network according to another embodiment of the present invention;

FIG. 5 illustrates an example software driver stack of an operating system (OS) of a host system according to an embodiment of the present invention;

FIG. 6 illustrates a block diagram of an example host system using NGIO/InfiniBand™ and VI architectures to support data transfers via a switched fabric according to an embodiment of the present invention;

FIG. 7 is an example disadvantageous arrangement which is useful in getting a more thorough understanding of the present invention;

FIG. 8 is a first advantageous embodiment of the present invention;

FIG. 9 is an example of the format of the message used in the embodiment of FIG. 8.

FIG. 10 is an example of the format of the completion information according to FIG. 8;

FIG. 11 is a second advantageous embodiment of the present invention;

FIG. 12 is the third advantageous embodiment of the present invention;

FIG. 13 is a fourth advantageous embodiment of the present invention;

FIG. 14 is a fifth advantageous embodiment of the present invention;

FIG. 15 shows a format for the transfer request message of the embodiment of FIG. 14.

FIG. 16 is a sixth advantageous embodiment of the present invention;

FIG. 17 is a seventh advantageous embodiment of the present invention.

### DETAILED DESCRIPTION

Before beginning a detailed description of the subject invention, mention of the following is in order. When appropriate, like reference numerals and characters may be used to designate identical, corresponding or similar components in differing figure drawings. Further, in the detailed description to follow, example sizes/models/values/ranges may be given, although the present invention is not limited to the same. With regard to description of any timing signals, the terms assertion and negation may be used in an intended generic sense. More particularly, such terms are used to avoid confusion when working with a mixture of “active-low” and “active-high” signals, and to represent the fact that the invention is not limited to the illustrated/described signals, but could be implemented with a total/partial reversal of any of the “active-low” and “active-high” signals by a simple change in logic. More specifically, the terms “assert” or “assertion” indicate that a signal is active independent of whether that level is represented by a high or low voltage, while the terms “negate” or “negation” indicate that a signal is inactive. As a final note, well known power/ground connections to ICs and other components may not be shown within the FIGS. for simplicity of illustration and discussion, and so as not to obscure the invention. Further, arrangements may be shown in block diagram form in order to avoid obscuring the invention, and also in view of the fact that specifics with respect to implementation of such block diagram arrangements are highly dependent upon the platform within which the present invention is to be implemented, i.e., such specifics should be well within purview of one skilled in the art. Where specific details (e.g., circuits, flowcharts) are set forth in order to describe example embodiments of the invention, it should be apparent to one skilled in the art that the invention can be practiced without, or with variation of, these specific details. Finally, it should be apparent that differing combinations of hardwired circuitry and software instructions can be used to implement embodiments of the present invention, i.e., the present invention is not limited to any specific combination of hardware and software.

The present invention is applicable for use with all types of data networks, I/O hardware adapters and chipsets, including follow-on chip designs which link together end stations such as computers, servers, peripherals, storage subsystems, and communication devices for data communications. Examples of such data networks may include a local area network (LAN), a wide area network (WAN), a campus area network (CAN), a metropolitan area network (MAN), a global area network (GAN), a wireless personal area network (WPAN), and a system area network (SAN), including newly developed computer networks using InfiniBand™ and those networks including channel-based, switched fabric architectures which may become available as computer technology advances to provide scalable performance. LAN systems may include Ethernet, FDDI (Fiber Distributed Data Interface) Token Ring LAN, Asynchronous Transfer Mode (ATM) LAN, Fiber Channel, and Wireless LAN. However, for the sake of simplicity, discussions will concentrate mainly on a host system including one or more hardware fabric adapters for providing physical links for channel connections in a simple data network having several example nodes (e.g., computers, servers and I/O units) interconnected by corresponding links and switches, although the scope of the present invention is not limited thereto.

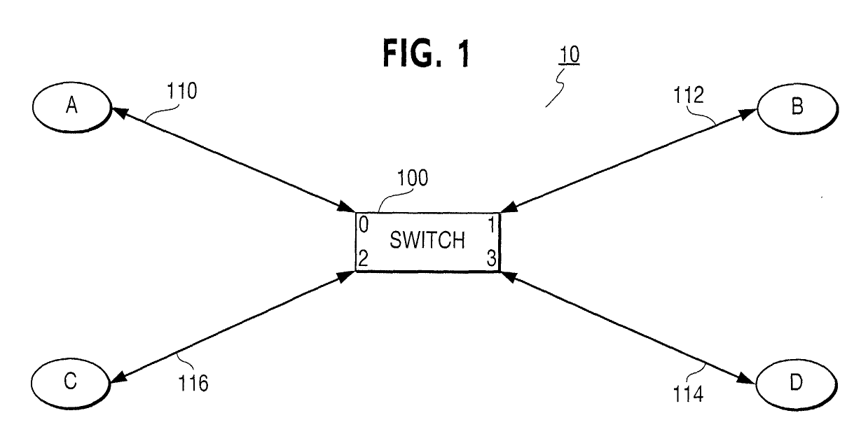

Attention now is directed to the drawings and particularly to FIG. 1, in which a simple data network 10 having several interconnected nodes for data communications according to an embodiment of the present invention is illustrated. As shown in FIG. 1, the data network 10 may include, for example, one or more centralized switches 100 and four different nodes A, B, C, and D. Each node (endpoint) may correspond to one or more I/O units and host systems including computers and/or servers on which a variety of applications or services are provided. I/O unit may include one or more processors, memory, one or more I/O controllers and other local I/O resources connected thereto, and can range in complexity from a single I/O device such as a local area network (LAN) adapter to large memory rich RAID subsystem. Each I/O controller (IOC) provides an I/O service or I/O function, and may operate to control one or more I/O devices such as storage devices (e.g., hard disk drive and tape drive) locally or remotely via a local area network (LAN) or a wide area network (WAN), for example.

The centralized switch 100 may contain, for example, switch ports 0, 1, 2, and 3 each connected to a corresponding node of the four different nodes A, B, C, and D via a corresponding physical link 110, 112, 114, and 116. Each physical link may support a number of logical point-to-point channels. Each channel may be a bi-directional communication path for allowing commands and data to flow between two connected nodes (e.g., host systems, switch/switch elements, and I/O units) within the network.

Each channel may refer to a single point-to-point connection where data may be transferred between endpoints (e.g., host systems and I/O units). The centralized switch 100 may also contain routing information using, for example, explicit routing and/or destination address routing for routing data from a source node (data transmitter) to a target node (data receiver) via corresponding link(s), and re-routing information for redundancy.

The specific number and configuration of endpoints or end stations (e.g., host systems and I/O units), switches and links shown in FIG. 1 is provided simply as an example data network. A wide variety of implementations and arrangements of a number of end stations (e.g., host systems and I/O units), switches and links in all types of data networks may be possible.

According to an example embodiment or implementation, the endpoints or end stations (e.g., host systems and I/O units) of the example data network shown in FIG. 1 may be compatible with the “Next Generation Input/Output (NGIO) Specification” as set forth by the NGIO Forum on Jul. 20, 1999, and the “InfiniBand™ Architecture Specification” as set forth by the InfiniBand™ Trade Association on late October 2000. According to the NGIO/InfiniBand™ Specification, the switch 100 may be an NGIO/InfiniBand™ switched fabric (e.g., collection of links, routers, switches and/or switch elements connecting a number of host systems and I/O units), and the endpoint may be a host system including one or more host channel adapters (HCAs), or a remote system such as an I/O unit including one or more target channel adapters (TCAs). Both the host channel adapter (HCA) and the target channel adapter (TCA) may be broadly considered as fabric adapters provided to interface endpoints to the NGIO/InfiniBand™ switched fabric, and may be implemented in compliance with “Next Generation I/O Link Architecture Specification: HCA Specification, Revision 1.0” as set forth by NGIO Forum on May 13, 1999, and/or the InfiniBand™ Specification for enabling the endpoints (nodes) to communicate to each other over an NGIO/InfiniBand™ channel(s).

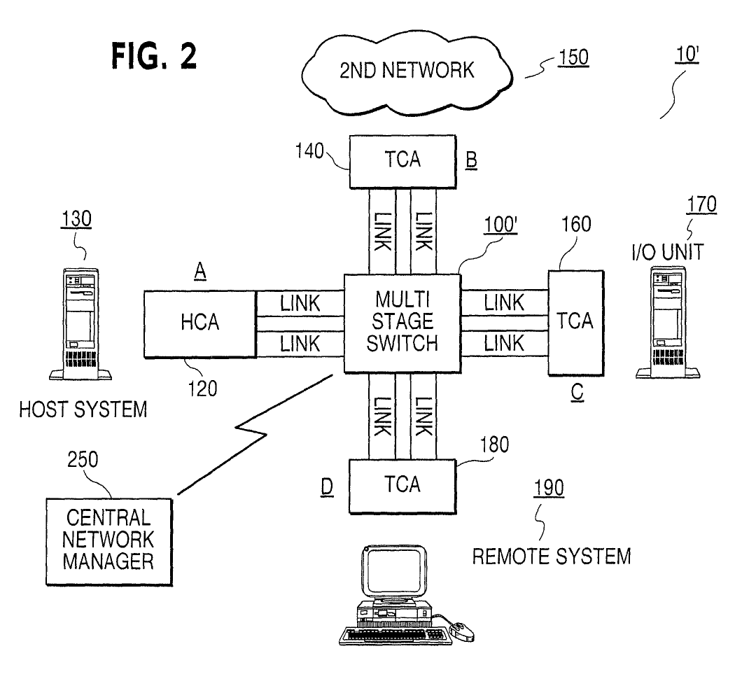

For example, FIG. 2 illustrates an example data network (i.e., system area network SAN) 10′ using an NGIO/InfiniBand™ architecture to transfer message data from a source node to a destination node according to an embodiment of the present invention. As shown in FIG. 2, the data network 10′ includes an NGIO/InfiniBand™ switched fabric 100′ (multi-stage switched fabric comprised of a plurality of switches) for allowing a host system and a remote system to communicate to a large number of other host systems and remote systems over one or more designated channels. A channel connection is simply an abstraction that is established over a switched fabric 100′ to allow two work queue pairs (WQPs) at source and destination endpoints (e.g., host and remote systems, and IO units that are connected to the switched fabric 100′) to communicate to each other. Each channel can support one of several different connection semantics. Physically, a channel may be bound to a hardware port of a host system. Each channel may be acknowledged or unacknowledged. Acknowledged channels may provide reliable transmission of messages and data as well as information about errors detected at the remote end of the channel. Typically, a single channel between the host system and any one of the remote systems may be sufficient but data transfer spread between adjacent ports can decrease latency and increase bandwidth. Therefore, separate channels for separate control flow and data flow may be desired. For example, one channel may be created for sending request and reply messages. A separate channel or set of channels may be created for moving data between the host system and any one of the remote systems. In addition, any number of end stations, switches and links may be used for relaying data in groups of cells between the end stations and switches via corresponding NGIO/InfiniBand™ links.

For example, node A may represent a host system 130 such as a host computer or a host server on which a variety of applications or services are provided. Similarly, node B may represent another network 150, including, but may not be limited to, local area network (LAN), wide area network (WAN), Ethernet, ATM and fibre channel network, that is connected via high speed serial links. Node C may represent an I/O unit 170, including one or more I/O controllers and I/O units connected thereto. Likewise, node D may represent a remote system 190 such as a target computer or a target server on which a variety of applications or services are provided. Alternatively, nodes A, B, C, and D may also represent individual switches of the NGIO fabric 100′ which serve as intermediate nodes between the host system 130 and the remote systems 150, 170 and 190.

The multi-stage switched fabric 100′ may include a fabric manager 250 connected to all the switches for managing all network management functions. However, the fabric manager 250 may alternatively be incorporated as part of either the host system 130, the second network 150, the I/O unit 170, or the remote system 190 for managing all network management functions. In either situation, the fabric manager 250 may be configured for learning network topology, determining the switch table or forwarding database, detecting and managing faults or link failures in the network and performing other network management functions.

Host channel adapter (HCA) 120 may be used to provide an interface between a memory controller (not shown) of the host system 130 (e.g., servers) and a switched fabric 100′ via high speed serial NGIO/InfiniBand™ links. Similarly, target channel adapters (TCA) 140 and 160 may be used to provide an interface between the multi-stage switched fabric 100′ and an I/O controller (e.g., storage and networking devices) of either a second network 150 or an I/O unit 170 via high speed serial NGIO/InfiniBand™ links. Separately, another target channel adapter (TCA) 180 may be used to provide an interface between a memory controller (not shown) of the remote system 190 and the switched fabric 100′ via high speed serial NGIO/InfiniBand™ links. Both the host channel adapter (HCA) and the target channel adapter (TCA) may be broadly considered as fabric adapters provided to interface either the host system 130 or any one of the remote systems 150, 170 and 190 to the switched fabric 100′, and may be implemented in compliance with “Next Generation I/O Link Architecture Specification: HCA Specification, Revision 1.0” as set forth by NGIO Forum on May 13, 1999 for enabling the endpoints (nodes) to communicate to each other over an NGIO/InfiniBand™ channel(s).

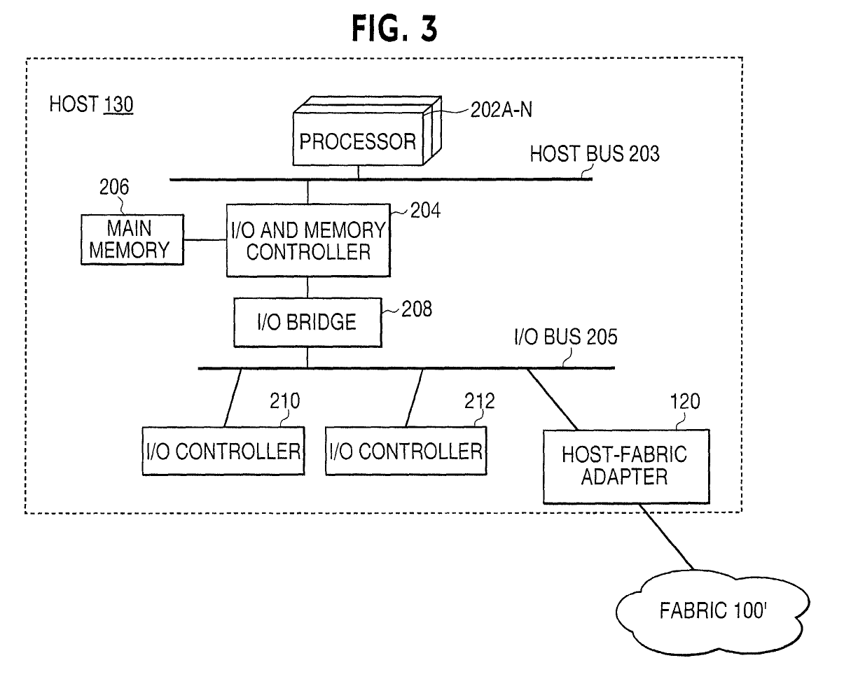

Returning to discussion, one example embodiment of a host system 130 may be shown in FIG. 3. Referring to FIG. 3, the host system 130 may include one or more processors 202A-202N coupled to a host bus 203. Each of the multiple processors 202A-202N may operate on a single item (I/O operation), and all of the multiple processors 202A-202N may operate on multiple items on a list at the same time. An I/O and memory controller 204 (or chipset) may be connected to the host bus 203. A main memory 206 may be connected to the I/O and memory controller 204. An I/O bridge 208 may operate to bridge or interface between the I/O and memory controller 204 and an I/O bus 205. Several I/O controllers may be attached to I/O bus 205, including an I/O controllers 210 and 212. I/O controllers 210 and 212 (including any I/O devices connected thereto) may provide bus-based I/O resources.

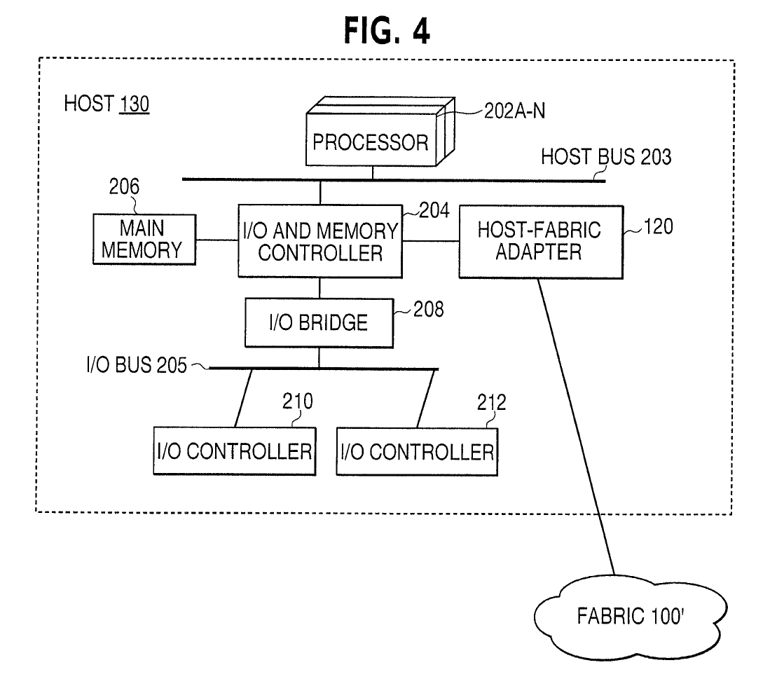

One or more host-fabric adapters 120 may also be connected to the I/O bus 205. Alternatively, one or more host-fabric adapters 120 may be connected directly to the I/O and memory controller (or chipset) 204 to avoid the inherent limitations of the I/O bus 205 as shown in FIG. 4. In either embodiment shown in FIGS. 3-4, one or more host-fabric adapters 120 may be provided to interface the host system 130 to the NGIO switched fabric 100′.

FIGS. 3-4 merely illustrate example embodiments of a host system 130. A wide array of system configurations of such a host system 130 may be available. A software driver stack for the host-fabric adapter 120 may also be provided to allow the host system 130 to exchange message data with one or more remote systems 150, 170 and 190 via the switched fabric 100′, while preferably being compatible with many currently available operating systems, such as Windows 2000.

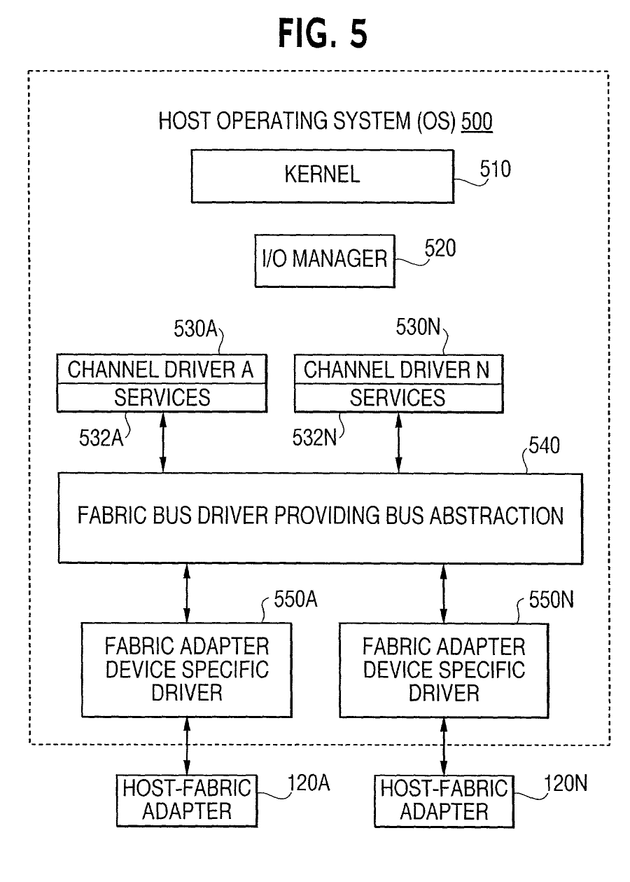

FIG. 5 illustrates an example software driver stack of a host system 130. As shown in FIG. 5, a host operating system (OS) 500 may include a kernel 510, an I/O manager 520, a plurality of channel drivers 530A-530N for providing an interface to various I/O controllers, and a host-fabric adapter software stack (driver module) including a fabric bus driver 540 and one or more fabric adapter device-specific drivers 550A-550N utilized to establish communication with devices attached to the switched fabric 100′ (e.g., I/O controllers), and perform functions common to most drivers. Such a host operating system (OS) 500 may be Windows 2000, for example, and the I/O manager 520 may be a Plug-n-Play manager.

Channel drivers 530A-530N provide the abstraction necessary to the host operating system (OS) to perform IO operations to devices attached to the switched fabric 100′, and encapsulate IO requests from the host operating system (OS) and send the same to the attached device(s) across the switched fabric 100′. In addition, the channel drivers 530A-530N also allocate necessary resources such as memory and Work Queues (WQ) pairs, to post work items to fabric-attached devices.

The host-fabric adapter software stack (driver module) may be provided to access the switched fabric 100′ and information about fabric configuration, fabric topology and connection information. Such a host-fabric adapter software stack (driver module) may be utilized to establish communication with a remote system (e.g., I/O controller), and perform functions common to most drivers, including, for example, host-fabric adapter initialization and configuration, channel configuration, channel abstraction, resource management, fabric management service and operations, send/receive IO transaction messages, remote direct memory access (RDMA) transactions (e.g., read and write operations), queue management, memory registration, descriptor management, message flow control, and transient error handling and recovery.

The host-fabric adapter (HCA) driver module may consist of three functional layers: a HCA services layer (HSL), a HCA abstraction layer (HCAAL), and a HCA device-specific driver (HDSD). For instance, inherent to all channel drivers 530A-530N may be a Channel Access Layer (CAL) including a HCA Service Layer (HSL) for providing a set of common services 532A-532N, including fabric services, connection services, and HCA services required by the channel drivers 530A-530N to instantiate and use NGIO/InfiniBand™ protocols for performing data transfers over NGIO/InfiniBand™ channels. The fabric bus driver 540 may correspond to the HCA Abstraction Layer (HCAAL) for managing all of the device-specific drivers, controlling shared resources common to all HCAs in a host system 130 and resources specific to each HCA in a host system 130, distributing event information to the HSL and controlling access to specific device functions. Likewise, one or more fabric adapter device-specific drivers 550A-550N may correspond to HCA device-specific drivers (for all type of brand X devices and all type of brand Y devices) for providing an abstract interface to all of the initialization, configuration and control interfaces of one or more HCAs. Multiple HCA device-specific drivers may be present when there are HCAs of different brands of devices in a host system 130.

More specifically, the fabric bus driver 540 or the HCA Abstraction Layer (HCAAL) may provide all necessary services to the host-fabric adapter software stack (driver module), including, for example, to configure and initialize the resources common to all HCAs within a host system, to coordinate configuration and initialization of HCAs with the HCA device-specific drivers, to control access to the resources common to all HCAs, to control access the resources provided by each HCA, and to distribute event notifications from the HCAs to the HCA Services Layer (HSL) of the Channel Access Layer (CAL). In addition, the fabric bus driver 540 or the HCA Abstraction Layer (HCAAL) may also export client management functions, resource query functions, resource allocation functions, and resource configuration and control functions to the HCA Service Layer (HSL), and event and error notification functions to the HCA device-specific drivers. Resource query functions include, for example, query for the attributes of resources common to all HCAs and individual HCA, the status of a port, and the configuration of a port, a work queue pair (WQP), and a completion queue (CQ). Resource allocation functions include, for example, reserve and release of the control interface of a HCA and ports, protection tags, work queue pairs (WQPs), completion queues (CQs). Resource configuration and control functions include, for example, configure a port, perform a HCA control operation and a port control operation, configure a work queue pair (WQP), perform an operation on the send or receive work queue of a work queue pair (WQP), configure a completion queue (CQ), and perform an operation on a completion queue (CQ).

The host system 130 may communicate with one or more remote systems 150, 170 and 190, including I/O units and I/O controllers (and attached I/O devices) which are directly attached to the switched fabric 100′ (i.e., the fabric-attached I/O controllers) using a Virtual Interface (VI) architecture in compliance with the “Virtual Interface (VI) Architecture Specification, Version 1.0,” as set forth by Compaq Corp., Intel Corp., and Microsoft Corp., on Dec. 16, 1997. VI architecture may support data transfers between two memory regions, typically on different systems over one or more designated channels of a data network. Each system using a VI Architecture may contain work queues (WQ) formed in pairs including inbound (receive) and outbound (send) queues in which requests, in the form of descriptors, are posted to describe data movement operation and location of data to be moved for processing and/or transportation via a switched fabric 100′. The VI Specification defines VI mechanisms for low-latency, high-bandwidth message-passing between interconnected nodes connected by multiple logical point-to-point channels. However, other architectures may also be used to implement the present invention.

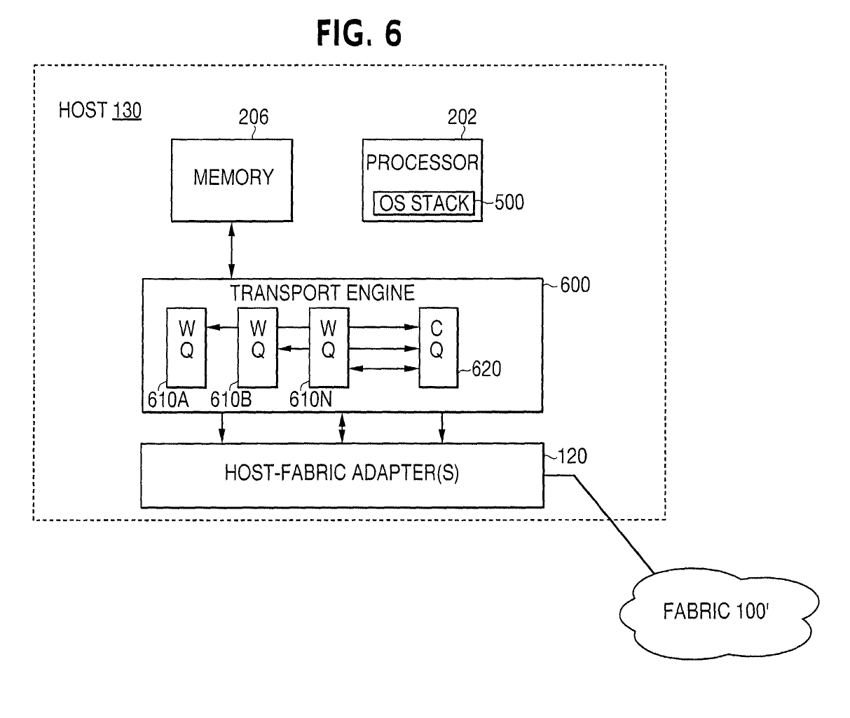

FIG. 6 illustrates an example host system using NGIO/InfiniBand™ and VI architectures to support data transfers via a switched fabric 100′. As shown in FIG. 6, the host system 130 may include, in addition to one or more processors 202 containing an operating system (OS) stack 500, a host memory 206, and at least one host-fabric adapter (HCA) 120 as shown in FIGS. 3-5, a transport engine 600 provided in the host-fabric adapter (HCA) 120 in accordance with NGIO/InfiniBand™ and VI architectures for data transfers via a switched fabric 100′. One or more host-fabric adapters (HCAs) 120 may be advantageously utilized to expand the number of ports available for redundancy and multiple switched fabrics.

As shown in FIG. 6, the transport engine 600 may contain a plurality of work queues (WQ) formed in pairs including inbound (receive) and outbound (send) queues, such as work queues (WQ) 610A-610N in which requests, in the form of descriptors, may be posted to describe data movement operation and location of data to be moved for processing and/or transportation via a switched fabric 100′, and completion queues (CQ) 620 may be used for the notification of work request completions. Alternatively, such a transport engine 600 may be hardware memory components of a host memory 206 which resides separately from the host-fabric adapter (HCA) 120 so as to process completions from multiple host-fabric adapters (HCAs) 120, or may be provided as part of kernel-level device drivers of a host operating system (OS). In one embodiment, each work queue pair (WQP) including separate inbound (receive) and outbound (send) queues has a physical port into a switched fabric 100′ via a host-fabric adapter (HCA) 120. However, in other embodiments, all work queues may share physical ports into a switched fabric 100′ via one or more host-fabric adapters (HCAs) 120. The outbound queue of the work queue pair (WQP) may be used to request, for example, message sends, remote direct memory access “RDMA” reads, and remote direct memory access “RDMA” writes. The inbound (receive) queue may be used to receive messages.

In such an example data network, NGIO/InfiniBand™ and VI hardware and software may be used to support data transfers between two memory regions, often on different systems, via a switched fabric 100′. Each host system may serve as a source (initiator) system which initiates a message data transfer (message send operation) or a target system of a message passing operation (message receive operation). Examples of such a host system include host servers providing a variety of applications or services and I/O units providing storage oriented and network oriented IO services. Requests for work (data movement operations such as message send/receive operations and RDMA read/write operations) may be posted to work queues (WQ) 610A-610N associated with a given fabric adapter (HCA), one or more channels may be created and effectively managed so that requested operations can be performed.

By utilizing data stream multiplexing, it is possible to have more data channels than are available in the hardware. This also allows the efficient transfer of data and control packets between host and target nodes in a data network.

In one approach to data stream multiplexing, the Send operation is used to transmit data from the requester application source buffer to a responder application destination buffer. However, this requires that the data is copied from destination system buffers and application buffers. It may also require that data is copied from application buffers into system buffers before being sent. The requestor application does not need to know about the location or size of the responder applications destinations buffer. The driver handles any segmentation and reassembly required below the application. The data is copied into system buffers if the data is located in multiple application buffers and the hardware does not support a gather operation or if the number of source application buffers exceeds the hardware gather capability. The data is transmitted across the wire into system buffers at the destination and then copies into the application buffers.

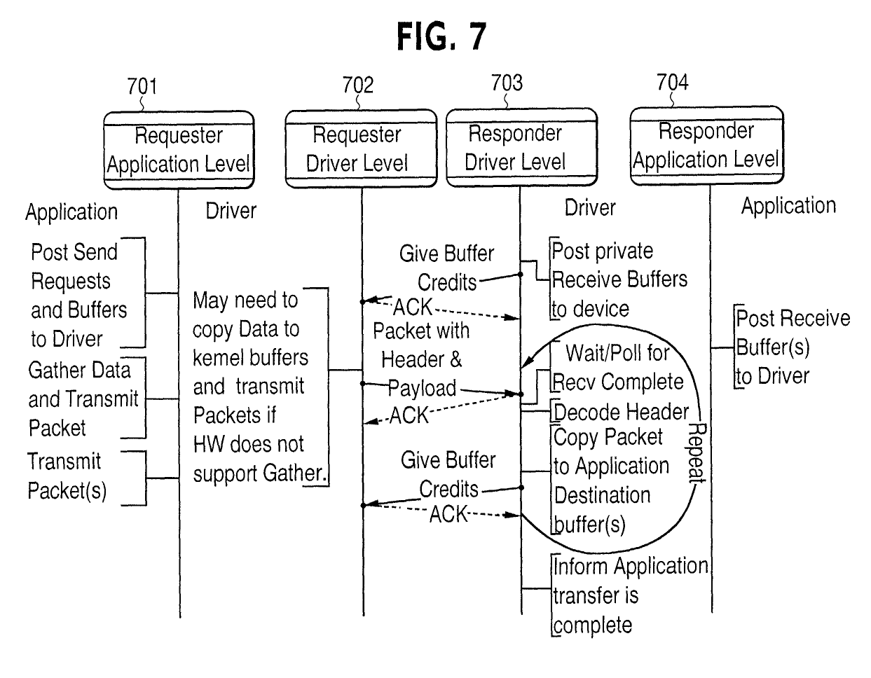

This is seen in FIG. 7 where the system includes a requestor application level 701, requester driver level 702, responder driver level 703 and a responder application level 704. As seen in FIG. 7, the responder driver level 703 provides buffer credits to requestor driver level 702 which is then acknowledged. The requestor application level 701 posts send requests and buffers to the driver, gathers the data and transmits a packet. The requester driver level may need to copy data to kernel buffers and transmit packets if the hardware does not support the gather operation. Also during this time, the responder application level 704 posts received buffers to the driver. The requester driver level sends a packet with a header and payload to the responder driver level 703. It is acknowledged and the information is decoded and the packet copied to the application destination buffers. When this is finished, the responder driver level gives buffer credits to the requestor driver level which is acknowledged and the responder driver level then informs the application level that the transfer is complete.

While this approach provides a workable multiplexing scheme, it is often necessary to copy the data from the destination system buffers into the application buffers. In order to avoid the necessity to copy this data, two alternate approaches are possible which reduce the number of messages and reduce the number of interrupts required to transfer data. This involves using a hardware RDMA Read and RDMA Write capability. The use of these operations result in an increase in the overall performance by reducing both latency and the utilization of the CPU when transferring data. The two different approaches are the requester driven approach and the responder driven approach. Each of these approaches has several possible embodiments. These approaches allow data to be moved directly from the source application buffer into the destination application buffer without copies to or from the system buffers.

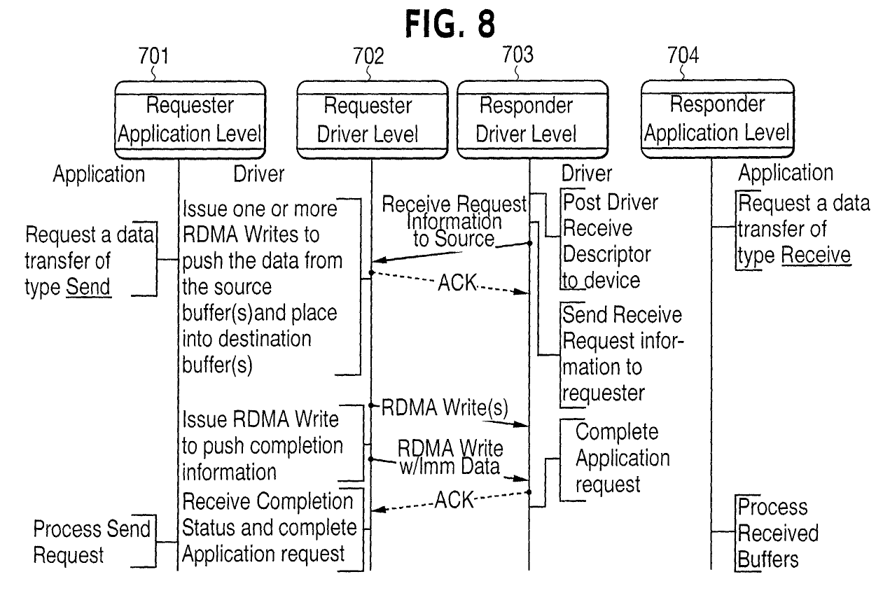

FIG. 8 shows a technique which requires little or no change to the application to convert from the system shown in FIG. 7. This technique still uses the Send and Receive operations. The destination driver communicates information about the application receive buffers to the source driver. The requester driver uses one or more RDMA Write commands to move the data from the requester application source buffer directly to the responders destination application buffer. At least one RDMA Write is required for each destination buffer.

Data networks using architectures described above allow the use of the RDMA Write operation to transfer a small amount of out of band data called immediate data. For example, the channel driver could use the immediate data field to transmit information about the data transferred via the RDMA Write operation, such as which buffer pool the data is being deposited in, the starting location within the pool and the amount of data being deposited. A side effect of the RDMA write request with immediate data is the generation of a completion entry that contains the immediate data. The responder can retrieve the contents of the immediate data field from that completion entry.

FIG. 8 again shows the requestor application level 701, the driver level 702, the responder driver level 703 and the responder application level 704. However, in this case the responder application level first requests a data transfer of the receive type. The responder driver level sends the receive request information to the requester. The requester application level requests a data transfer of the send type. The requestor driver level issues one or more RDMA Writes to push the data from the source buffer and place it into the destination buffer. When this is completed, the responder driver level acknowledges the completion to the requestor driver level.

It should be noted that the requester application has no knowledge of the buffers specified by the destination application. However, the requester driver must have knowledge of the destination data buffers, specifically the address of the buffer and any access keys.

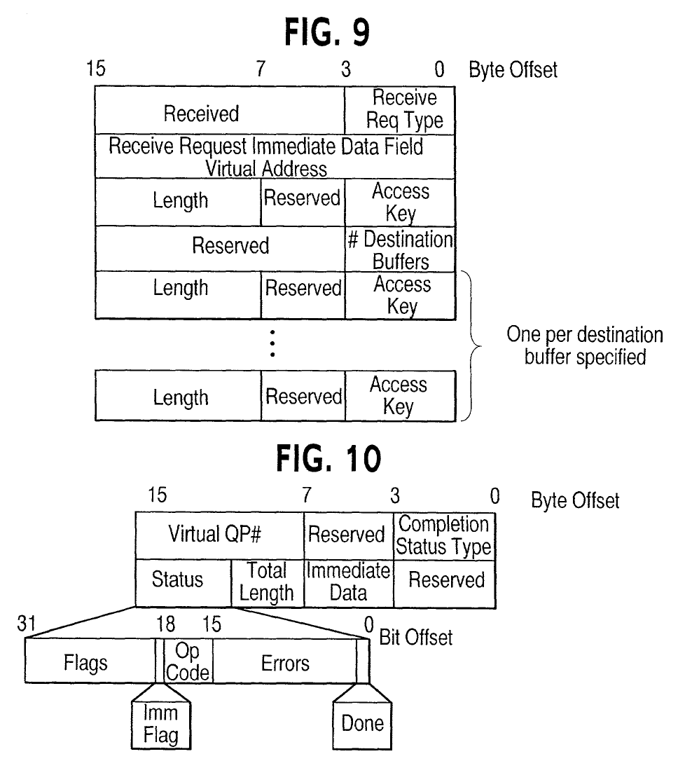

FIG. 9 shows an example of the format of a receive request message such as utilized in the system shown in FIG. 8.

FIG. 10 shows an example of the format of the completion information contained in the RDMA Write message according to FIG. 8.

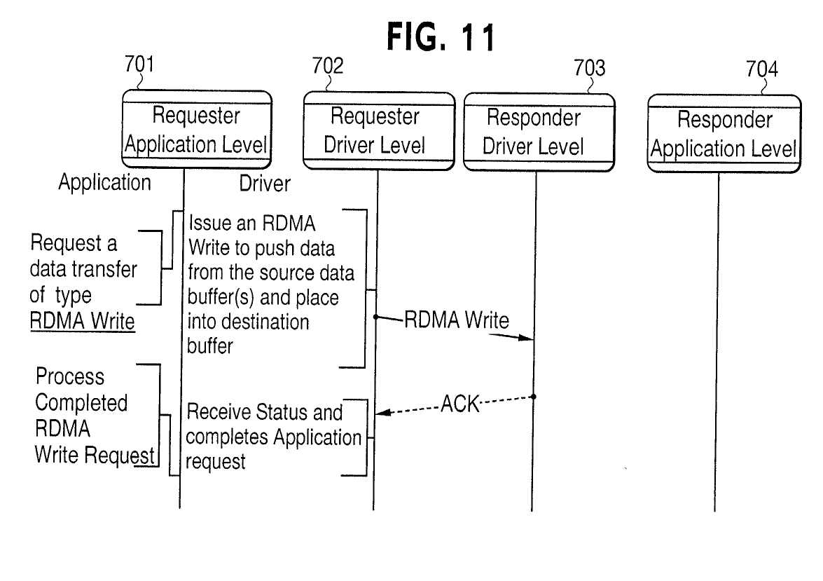

Another embodiment of the system is shown in FIG. 11 which is a requester driven approach using an RDMA Write operation. In this system the requester application uses the RDMA Write operation to transfer data from its source buffers directly into the responder applications destination buffer. The requester application must know the location and access key to the responder application buffer.

FIG. 11 shows a similar arrangement of requester application level, requester driver level, responder driver level and responder application level. In this arrangement, the requester application level requests a data transfer of the RDMA Write type. The requester driver level issues the RDMA Write to push data from the source data buffer and place it into the destination buffer. The responder driver level acknowledges this to the requester driver level which indicates the completion of the request.

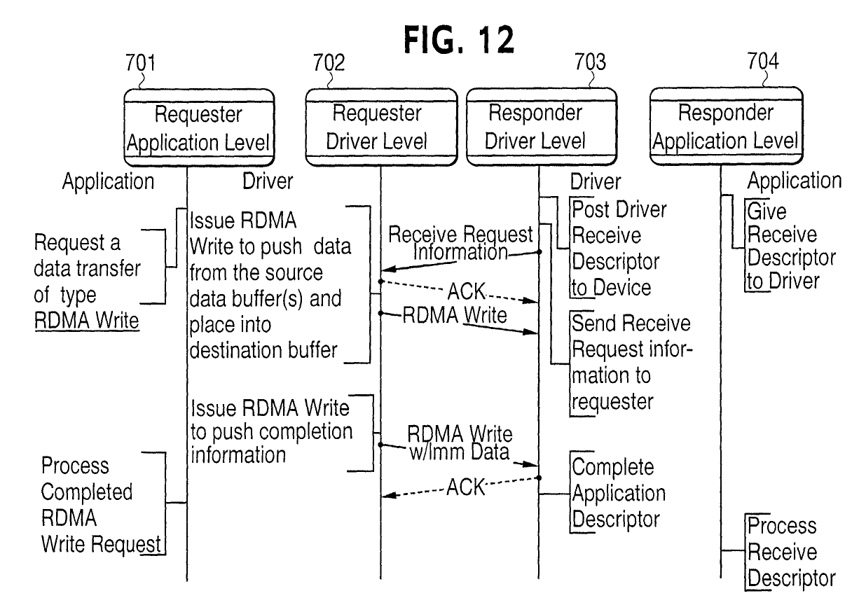

FIG. 12 shows another embodiment which is similar to that shown in FIG. 11 except that the requester application requests an RDMA Write with immediate data. In this case the responder application must post a received descriptor because the descriptor is consumed when the immediate data is transferred. As in FIG. 11, the requester application is assumed to know the location and access key to the responder application buffer.

Thus, in FIG. 12 the requester application level requests a data transfer of the RDMA Write type. At the same time, the responder application level gives the received descriptor to the driver which sends the receive request information to the requester. The requester driver level issues the RDMA Write to push data from the source data buffer and place it into the destination buffer. When this is completed, the responder driver level indicates its completion. The requester application level processes the completed RDMA Write request and the responder application level processes the received descriptor.

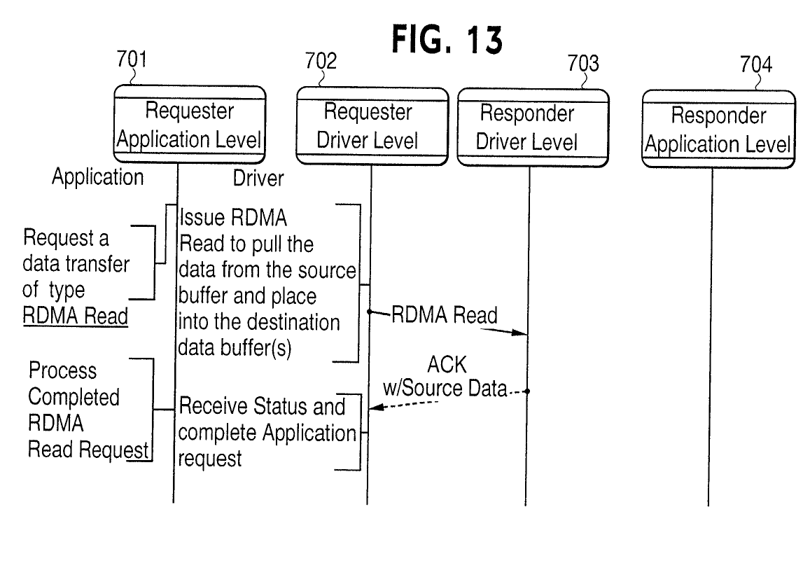

FIG. 13 is an embodiment where data is transferred from the responder to the requester using an RDMA Read operation initiated by the requestor application. The responder application must know the location and access key to the requester application destination buffer. In this embodiment, the requester application level requests a data transfer of the RDMA read type. The requester driver level issues the RDMA read to pull the data from the source buffer and place it into the destination data buffer. The responder driver level acknowledges this with the source data to the requester driver level, which receives the status and completes the application request. The requester application level then processes the completed RDMA Read request.

The other type of approach is the responder driven approach which is used when the responder application does not want to give the requestor application direct access to its data buffers or when the responder application wants to control the data rte or when the transfer takes place. In these embodiments, the responder application is assumed to have information about the requestor application buffers prior to the message transfer. In the first two embodiments, where the data is transferred from the requester application to the responder application, an RDMA Read command is used to poll the data from the requestor application data buffer into the responder application data buffer. In the third embodiment, where the data is transferred from the responder application to the requestor application, an RDMA Write is used to push the data from the responder application data buffer to the requester application data buffer.

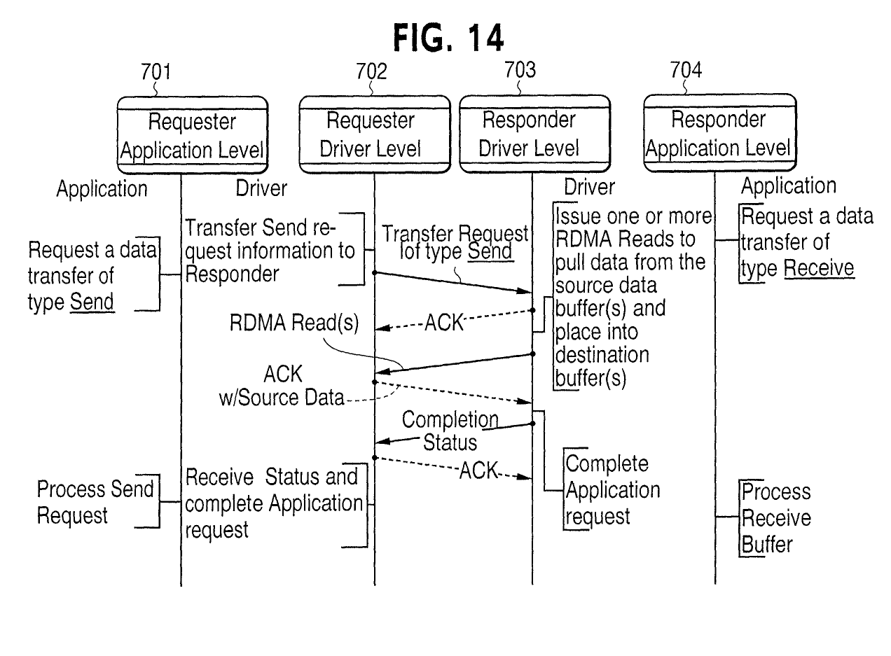

The embodiment of FIG. 14 requires little or no changes to the application to convert it from the original arrangement shown in FIG. 7. This embodiment still uses the Send/Receive arrangement. The requester driver communicates information about the application data buffers to the responder driver. The responder driver uses one or more RDMA Read commands to pull the data from the source application buffer directly into the destination application buffer. At least one RDMA Read is required for each source application buffer. This can be used when the responder application does not want to provide memory access to the requestor application.

As shown in FIG. 14, the requester application level requests a data transfer of the Send type. The requester driver level transfers the send request information to the responder driver level which acknowledges this back. The responder driver level also issues one or more RDMA Reads to pull data from the source data buffer and place into the destination buffer. These are acknowledged by the requester driver level. The responder driver level also indicates the completion status to the requester driver level. The requestor driver level indicates a receive status and the completion of the application request. The requester application level then processes the send request.

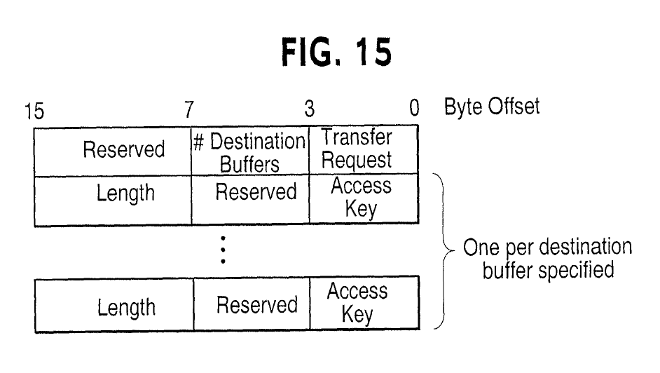

FIG. 15 shows the transfer request message format for the embodiment shown in FIG. 14.

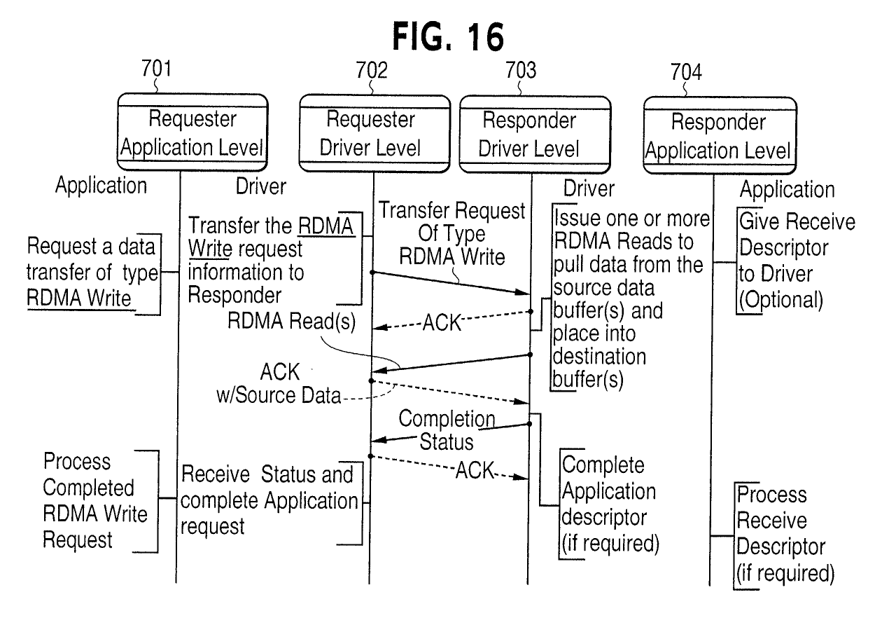

The embodiment of FIG. 16 shows a responder driven approach using an RDMA Write request. The transfer request contains information to the responder driver regarding the location of the requester data buffers. The responder driver must have knowledge of the source data buffer and specifically the address of the buffer and the access keys. Thus, FIG. 16 shows that the requestor application level requests the data transfer of the RDMA Write type. The requester driver level transfers this request information to the responder. Optionally, the responder application level can give a receive descriptor to the driver. The requester driver level transfers the RDMA Write request to the responder driver level which issues one or more RDMA Reads to pull data from the source data buffer and place them into the destination buffer. These Reads are acknowledged by the requestor driver level with the source data. The responder driver level sends the completion of the application status to the requester driver level which receives the status and indicates the completion of the application request. The requestor application level then indicates the completion of the RDMA Write request.

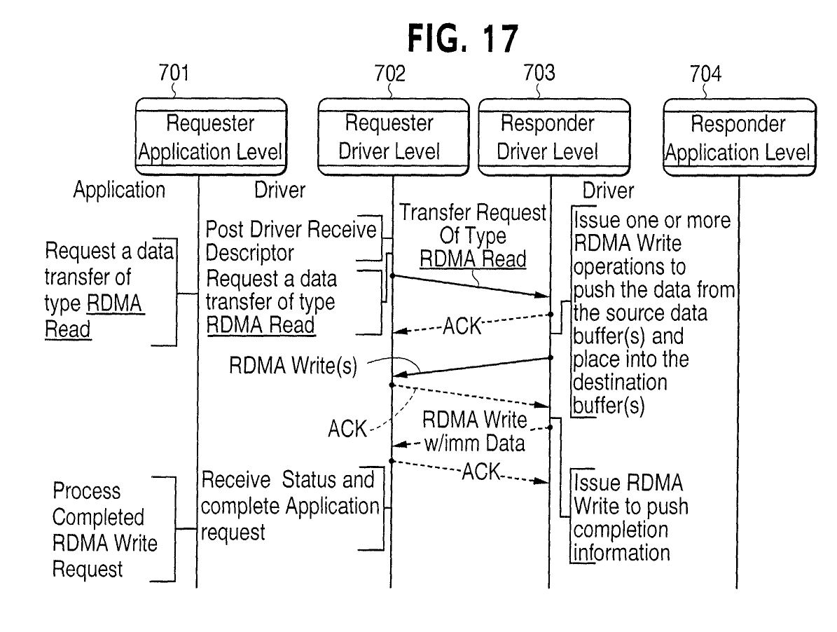

FIG. 17 shows another embodiment using a responder driven approach with an RDMA Read request. The transfer request contains information to the responder driver regarding the location of the requestor application data buffer. The requester application must have knowledge of the source buffer especially the address of the buffer and any access keys.

As seen in FIG. 17, the requester application level requests a data transfer of the RDMA Read type. The requester driver level posts a driver receive descriptor and requests a data transfer of the RDMA Read type. The responder driver level receives this request and issues one or more RDMA Write operations to push the data from the source data buffer and place it into the destination data buffer. This is acknowledged by the requester driver level. The responder driver level issues an RDMA Write to push the completion information with the immediate data to the requester driver level. The requester driver level receives the status information and the completion of the application request. The requester application level then indicates the completion of the RDMA Write request.

In concluding, reference in the specification to “one embodiment”, “an embodiment”, “example embodiment”, etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments. Furthermore, for ease of understanding, certain method procedures may have been delineated as separate procedures; however, these separately delineated procedures should not be construed as necessarily order dependent in their performance, i.e., some procedures may be able to be performed in an alternative ordering, simultaneously, etc.

This concludes the description of the example embodiments. Although the present invention has been described with reference to a number of illustrative embodiments thereof, it should be understood that numerous other modifications and embodiments can be devised by those skilled in the art that will fall within the spirit and scope of the principles of this invention. More particularly, reasonable variations and modifications are possible in the component parts and/or arrangements of the subject combination arrangement within the scope of the foregoing disclosure, the drawings and the appended claims without departing from the spirit of the invention. In addition to variations and modifications in the component parts and/or arrangements, alternative uses will also be apparent to those skilled in the art.

In the claims:

1. A method for transmitting multiple data streams in a data network using data stream multiplexing, comprising:
providing a requester node which includes an application level and a driver level;
providing a responder node including an application level and a driver level;
moving data from said requester driver level to said responder driver level;
said data moving being driven by said requester node utilizing an RDMA operation.

2. The method according to claim 1, where the RDMA operation is an RDMA Write operation.

3. Method according to claim 2, wherein the RDMA Write operation includes immediate data.

4. The method according to claim 1, where the RDMA operation is an RDMA Read operation.

5. The method according to claim 1, wherein the step of moving data avoids the copying of data from application buffers into system buffers before being sent.

6. A method for transmitting multiple data streams in a data network using data stream multiplexing, comprising:
providing a requestor node which includes an application level and a driver level;
providing a responder node including an application level and a driver level;
moving data from said requester driver level to said responder driver level;
said data moving being driven by said responder node utilizing an RDMA operation.

7. The method according to claim 6, where the RDMA operation is an RDMA Write operation.

8. Method according to claim 7, wherein the RDMA Write operation includes immediate data.

9 The method according to claim 6, where the RDMA operation is an RDMA Read operation.

10. The method according to claim 6, wherein the moving of data avoids the copying of data from application buffers into system buffers before being sent.

11. A data network for multiplexing data streams using an RDMA operation, comprising:
a plurality of nodes;
a plurality of links joining said nodes in a network so that data may be transmitted between nodes;
one of said nodes being a requester node and including an application level and a driver level;
one of said nodes being a responder node having a driver level and an application level;
said requester node and said responder node being in communication and transferring data therebetween using RDMA operations and avoiding copying data from application buffers into system buffers before being sent.

12. The apparatus according to claim 11, wherein the RDMA operation is an RDMA Write operation.

13. Apparatus according to claim 12, where the RDMA Write operation includes immediate data.

14. The apparatus according to claim 11, wherein the RDMA operation is an RDMA Read operation.

15. The apparatus according to claim 11, wherein the data moving is requester driven.

16. The apparatus according to claim 11, wherein the data moving is responder driven.
